(19) United States
(12) Patent Application Publication
(10) Pub. No.: US 2008/0161532 A1
(43) Pub. Date: Jul. 3, 2008

(54) COMPOSITION FOR FORMING LOW-DIELECTRIC-CONSTANT FILM, INSULATING FILM, AND ELECTRONIC DEVICE

(75) Inventor: Kaoru IWATO, Shizuoka (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/964,872

(22) Filed: Dec. 27, 2007

(30) Foreign Application Priority Data
Dec. 27, 2006 (JP) 2006-352273

(51) Int. Cl. C08G 73/00

(52) U.S. Cl. 528/392

(57) ABSTRACT

A composition for forming a low-dielectric-constant film includes a compound represented by the following formula (A):

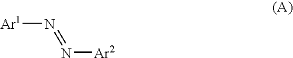

wherein each of Ar¹ and Ar² independently represents an aryl group that may have a substituent.

### BACKGROUND OF THE INVENTION

1. Field of the Invention

The present invention relates to a composition for forming a low-dielectric-constant film, an insulating film available using the composition, and an electronic device having the insulating film.

2. Description of the Related Art

As an interlayer insulating film of semiconductor devices and the like, a silica (SiO₂) film formed by a vacuum process such as vapor phase deposition (CVD) has conventionally been used popularly. In recent years, use of an application type insulating film composed mainly of a hydrolysate of a tetraalkoxysilane, which film is called an “SOG (Spin on Glass) film”, has been started. A low-dielectric-constant interlayer insulating film composed mainly or a polyorganosiloxane, which film is called an “organic SOG film”, is developed in order to satisfy requirements for high integration of semiconductor devices.

The dielectric constant of a CVD-SiO₂ film showing the lowest dielectric constant among films made of an inorganic material is still about 4. An SiOF film recently investigated as a low-dielectric-constant CVD film has a dielectric constant of from about 3.3 to 3.5, but it has a problem that owing to high hygroscopicity, its dielectric constant increases during use.

An organic high-molecular film showing a dielectric constant as low as from 2.5 to 3.0, on the other hand, has also the problem that owing to a low glass transition point of from 200 to 350° C. and a large coefficient of thermal expansion, it may damage interconnects. An organic SOG film, on the other hand, has the drawback that it may be oxidized, during formation of a multilevel interconnect pattern, by oxygen plasma ashing used for peeling of a resist, and cause cracks.

Moreover, organic resins including organic SOG have low adhesion to an interconnect material such as aluminum, an alloy having aluminum as a main component, copper or an alloy having copper as a main component. Voids (voids formed between an interconnect and an insulating material) therefore appear around the interconnect and penetration of water into the voids may presumably corrode the interconnect. The voids around the interconnect may cause a short circuit between interconnect layers when misalignment occurs during opening of a via hole to form multilevel interconnects and thereby deteriorate reliability.

Under such situations, low-dielectric-constant materials containing a polycyclic carbon cycle compound having a cage structure are proposed as an insulating film material excellent in low dielectric property, insulation property, heat resistance and durability. Among those, a polymer available by polymerizing a compound with a carbon-carbon triple bond is disclosed as an excellent material (US 2005-0276964 A1).

An insulating film available from a polymer of a compound with a carbon-carbon triple bond has markedly high heat resistance and a low dielectric constant and thus has achieved excellent results as a film made of an organic compound, but there is still a demand for the development of an insulating film having improved heat resistance in addition to these advantages.

### SUMMARY OF THE INVENTION

The invention provides a polymer, preparation process of the polymer, and a composition for forming a low-dielectric-constant film, each for overcoming the above-described problem. The invention specifically provides a composition (coating solution) for forming a low-dielectric-constant film capable of forming an insulating film to be used as an interlayer film of electronic devices and having a low dielectric constant and excellent mechanical strength and thus having good film properties. The invention also provides an interlayer insulating film of an electronic device available by using the coating solution and an electronic device having the insulating film as a constituent layer. An “insulating film” is also referred to as a “dielectric film” or a “dielectric insulating film”, and these terms are not substantially distinguished

The present inventors have found that the above-described problem can be overcome by any one of the following constitutions <1> to <6>.

<1> A composition for forming a low-dielectric-constant film, the composition comprising:

a compound represented by the following formula (A):

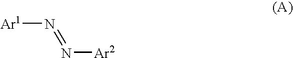

wherein

each of Ar¹ and Ar² independently represents an aryl group that may have a substituent.

<2> The composition according to Claim 1, further comprising:

a compound having a carbon-carbon triple bond.

<3> The composition according to Claim 2, wherein

the compound having a carbon-carbon triple bond has a cage structure.

<4> The composition according to Claim 3, wherein

the cage structure is selected from the group consisting of adamantane, biadamantane, diamantane, triamantane, and tetramantane.

<5> An insulating film formed of the composition according to Claim 1.

<6> An electronic device comprising the insulating film according to Claim 5.

### DETAILED DESCRIPTION OF THE INVENTION

The present invention will hereinafter be described specifically.

### (Compound Represented by the Formula (A))

First, a compound represented by the formula (A) will be described.

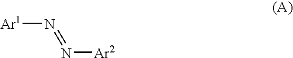

In the above formula, Ar¹ and Ar² each represents an aryl group and they may be the same or different and they may have a substituent.

In the formula (A), the aryl group represented by Ar¹ or Ar² is an aromatic carbocyclic group (an aromatic C₆₋₃₀ carbocyclic group such as phenyl, naphthyl, or anthranyl) or an aromatic heterocyclic group (an aromatic C₁₋₃₀ heterocyclic group such as 2-pyridyl, 4-pyridyl, 2-furyl or 2-thienyl), with the aromatic carbocyclic group being preferred.

Preferred examples of the substituent for the aryl group represented by Ar¹ or Ar² include halogen atoms (fluorine, chlorine, bromine and iodine atoms), linear, branched or cyclic C₁₋₃₀ alkyl groups (such as methyl, t-butyl, cyclopentyl, and cyclohexyl), C₂₋₃₀ alkenyl groups (such as vinyl and propenyl), C₂₋₃₀ alkynyl groups (such as ethynyl and phenylethynyl), C₆₋₃₀ aryl groups (such as phenyl, 1-naphthyl, and 2-naphthyl), C₂₋₃₀ acyl groups (such as benzoyl), C₂₋₃₀ alkoxycarbonyl groups (such as methoxycarbonyl), C₆₋₃₀ aryloxycarbonyl groups (such as phenoxycarbonyl and 1-naphthoxycarbonyl), C₁₋₃₀ carbamoyl groups (such as N,N-diethylcarbamoyl and N-phenylcarbamoyl), C₁₋₃₀ alkoxy groups (such as methoxy, butoxy, and dodecyloxy), C₆₋₃₀ aryloxy groups (such as phenoxy), C₂₋₃₀ acyloxy groups (such as acetoxy, octanoyloxy, benzoyloxy and 2-naphthyloxy), C₁₋₃₀ acylamino groups (such as acetyl, propanoylamino, benzoylamino, and 2-naphthylcarbonylamino), C₆₋₃₀ arylsulfonyl groups (such as phenylsulfonyl), nitro group, cyano group, and silyl groups (such as triethoxysilyl, methyldiethoxysilyl and trivinylsilyl). Of these, alkyl groups, aryl groups, aryloxy groups, alkoxycarbonyl groups, aryloxycarbonyl groups, acyloxy groups, acylamino groups and carbamoyl groups are preferred. The above-exemplified groups capable of having a substituent further may be substituted with these substituents.

The compound represented by the formula (A) has a molecular weight of preferably 300 or greater, more preferably 500 or greater, most preferably 700 or greater. The compound having a molecular weight of 300 or greater is preferred because a decrease in its concentration in the film which will otherwise occur by evaporation can be prevented.

As the compound represented by the formula (A), a plurality of the compounds represented by the formula (A) connected via a single bond or an arbitrary linking group may be used.

The compound represented by the formula (A) may be a commercially available one or may be synthesized in a known manner.

The content of the compound represented by the formula (A) is typically from 0.1 to 100 mass %, preferably from 0.3 to 50 mass %, more preferably from 0.5 to 40 mass %, most preferably from 1.0 to 30 mass %, each in the solid content. A greater content is preferred when the compound represented by the formula (A) is added to bring about improving effects, while a smaller content is preferred from the viewpoint of a film forming property.

The followings are preferred specific examples of the compound represented by the formula (A), but the invention is not limited by them.

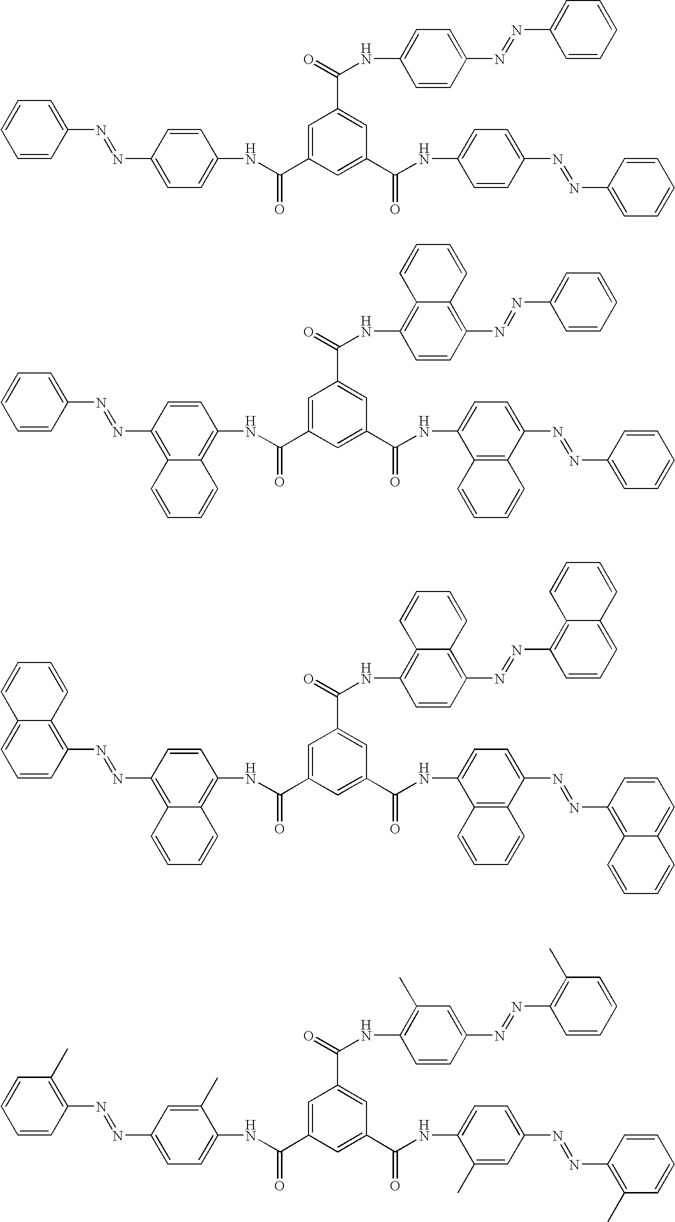

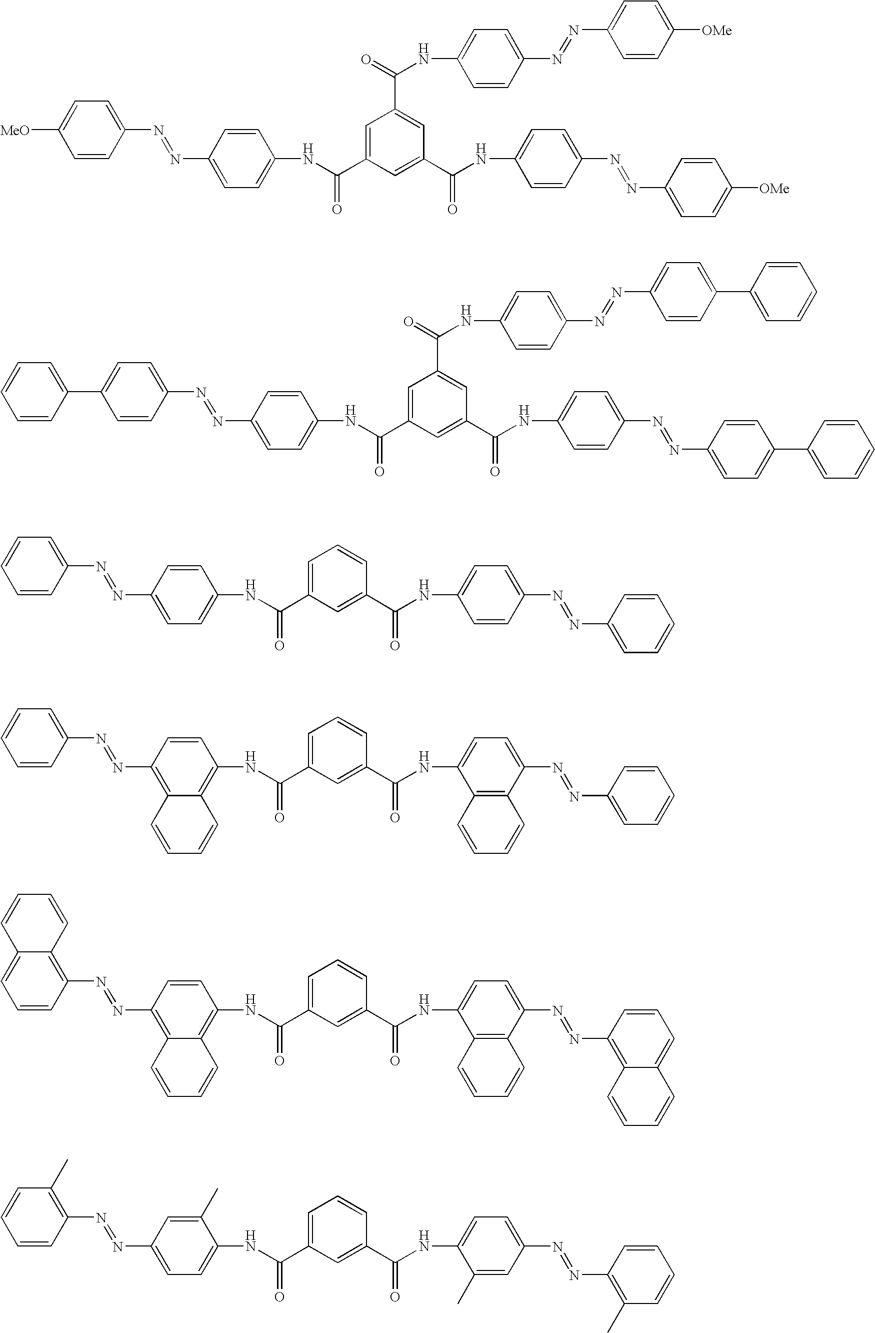

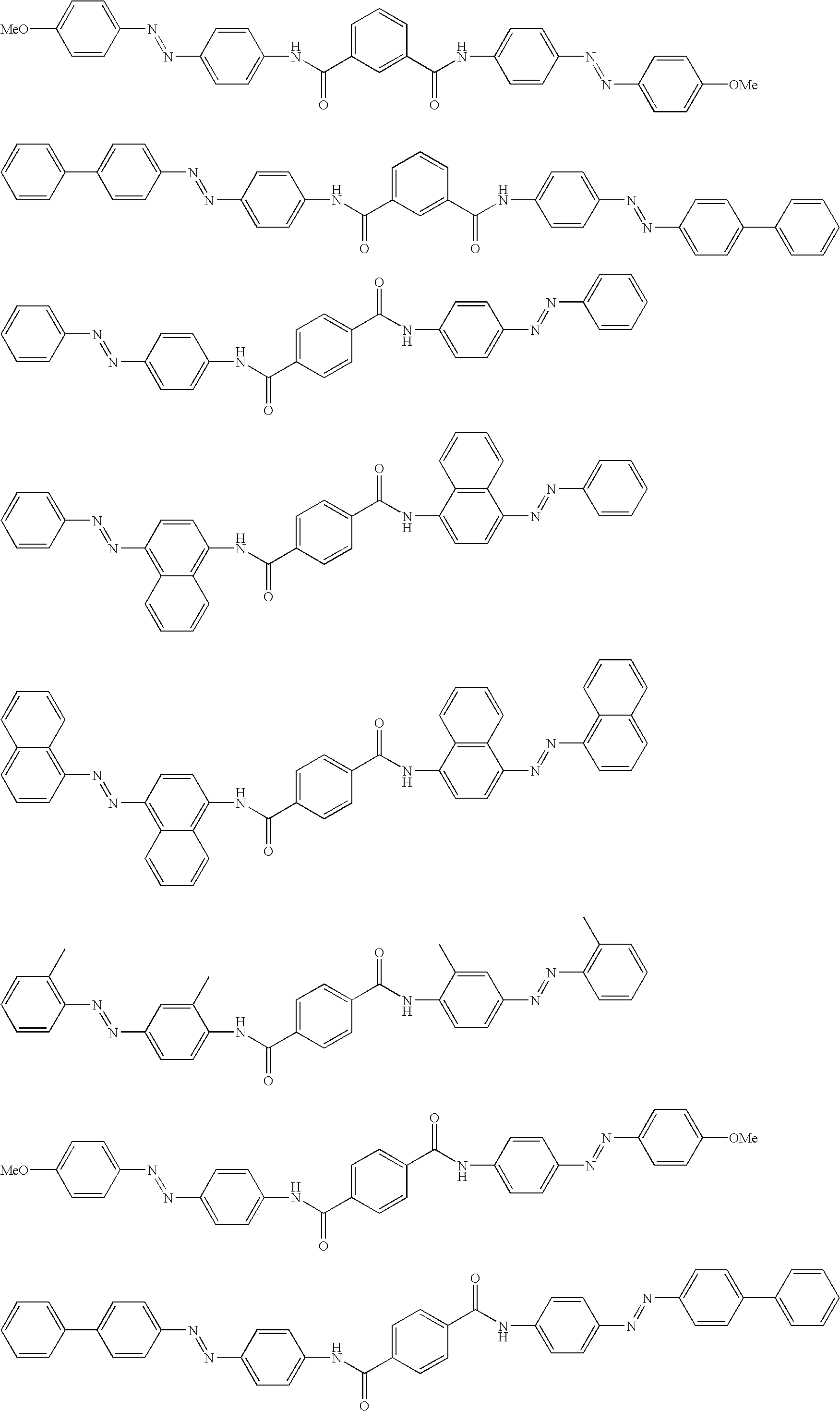

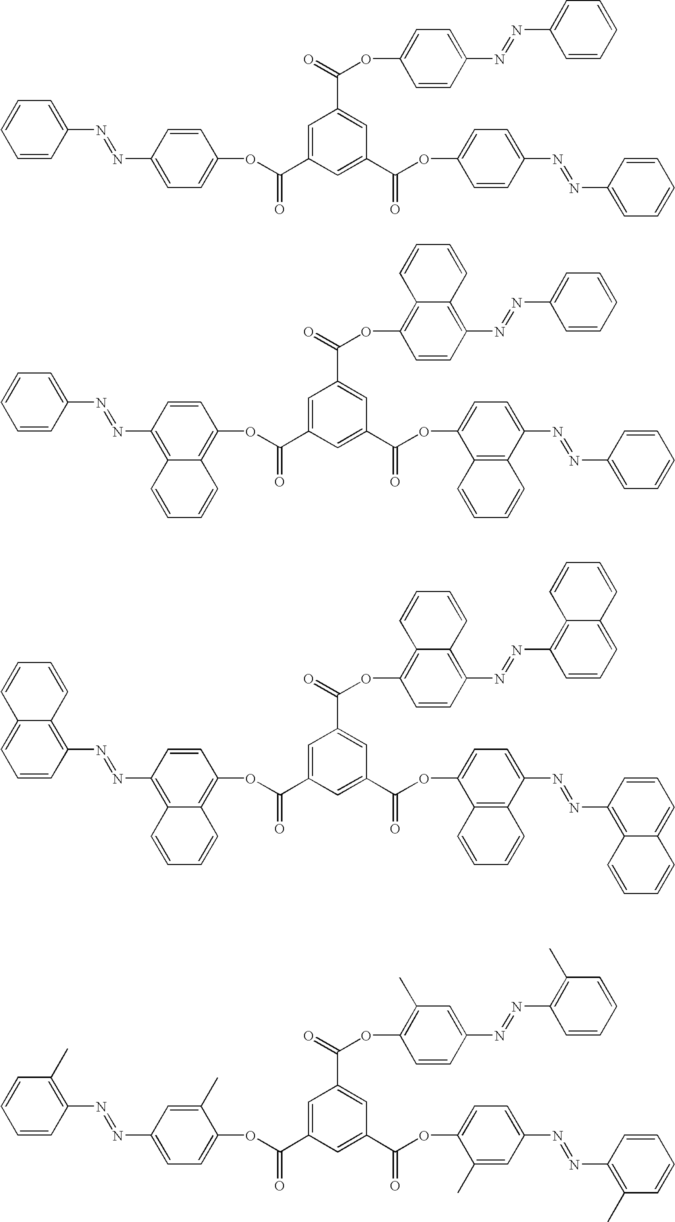

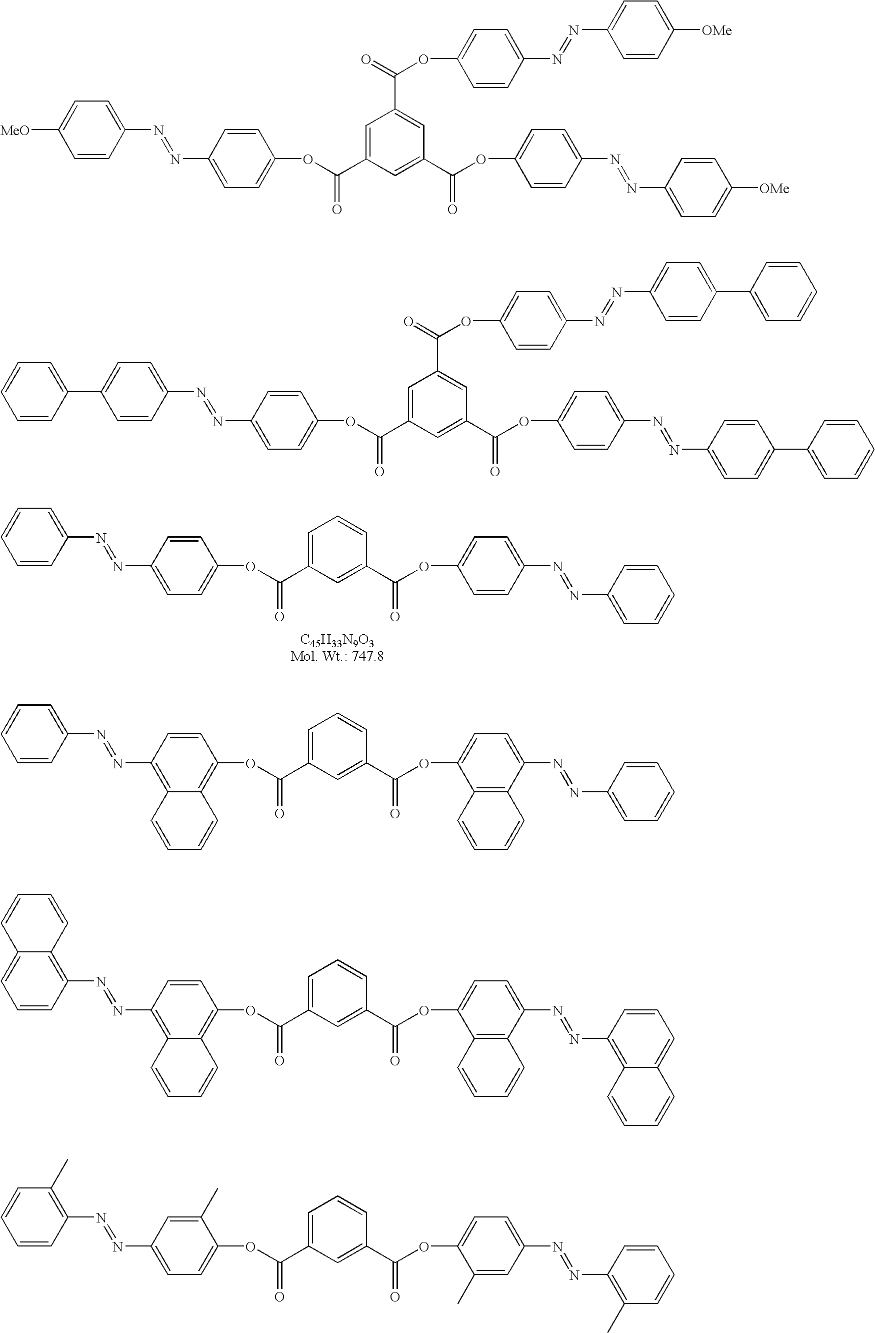

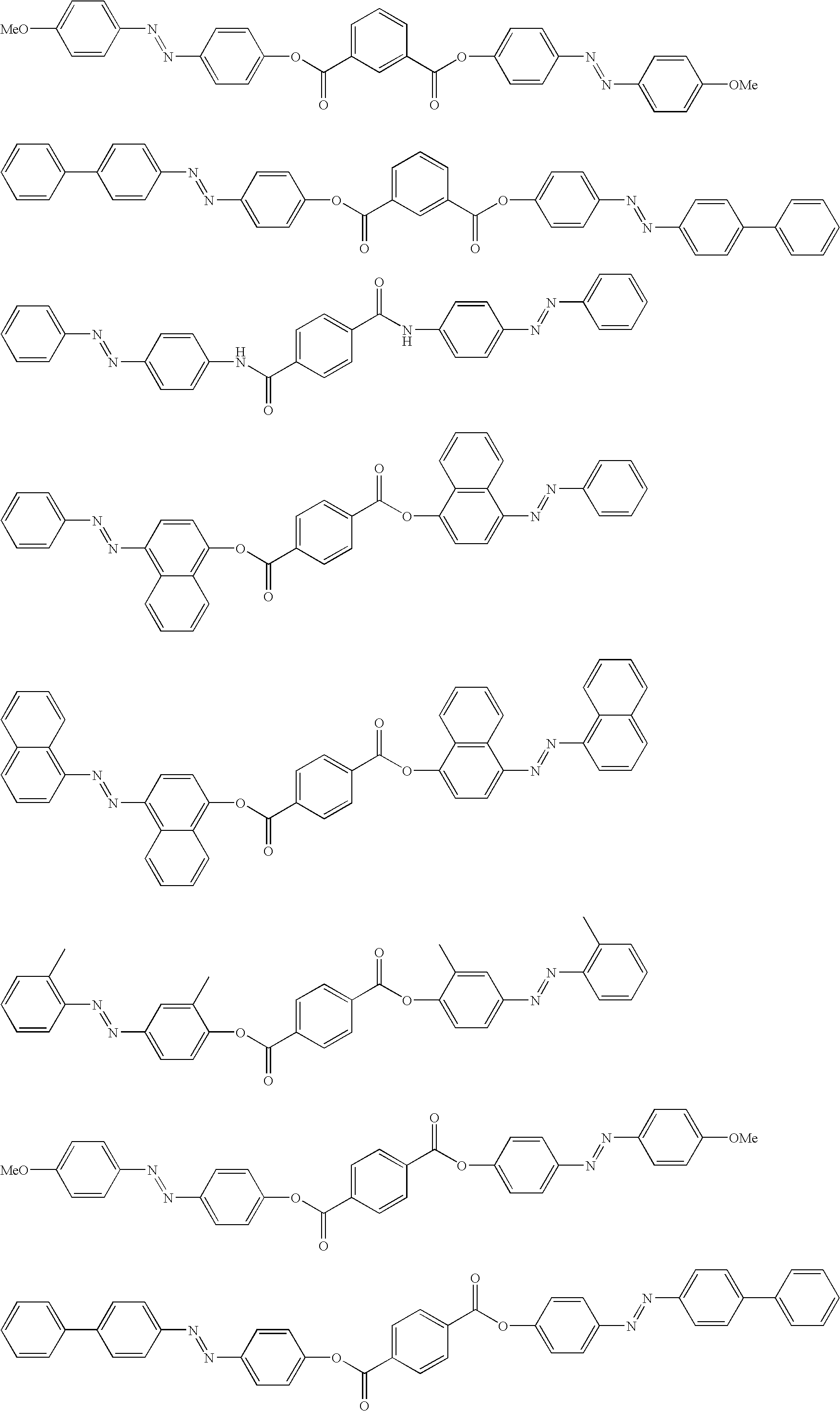

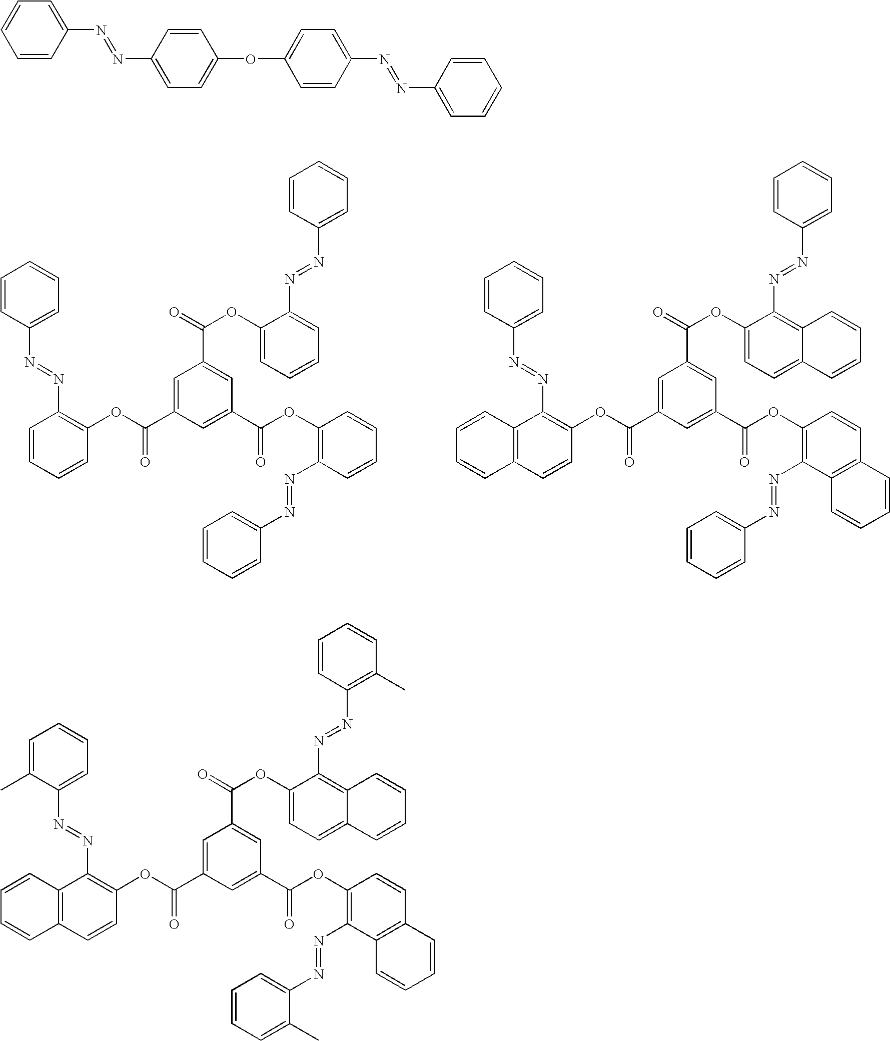

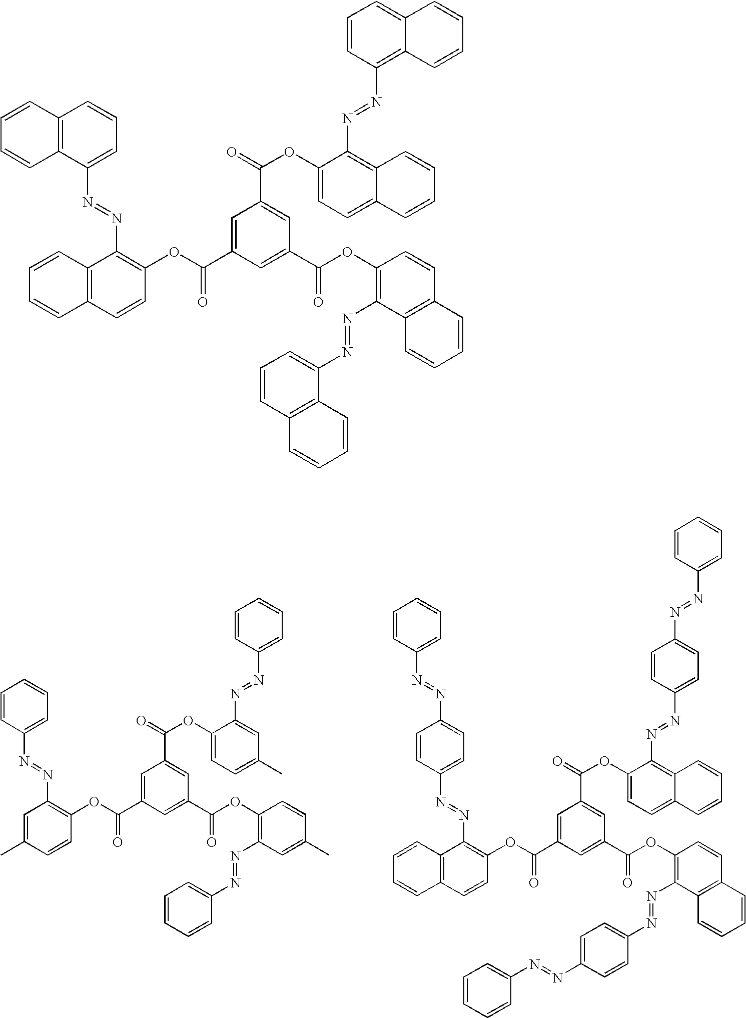

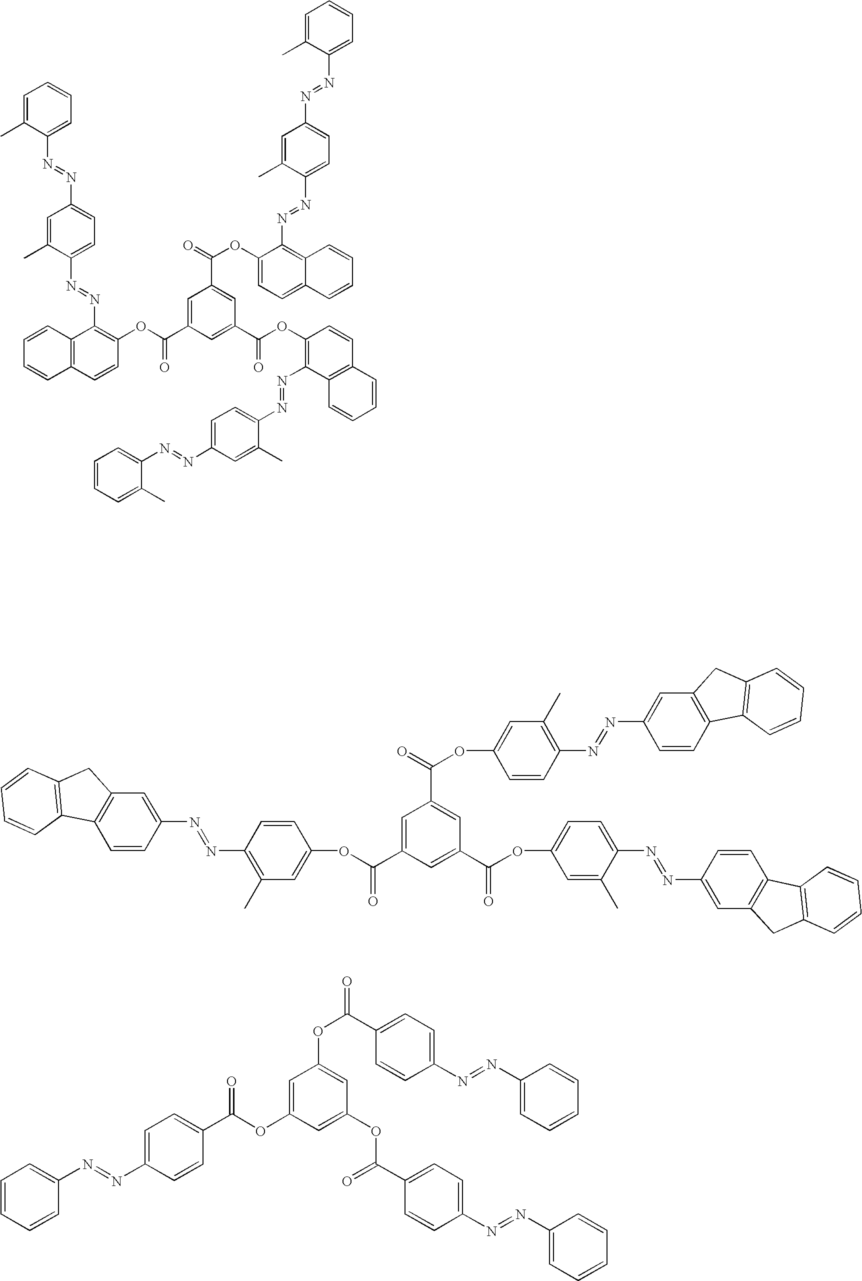

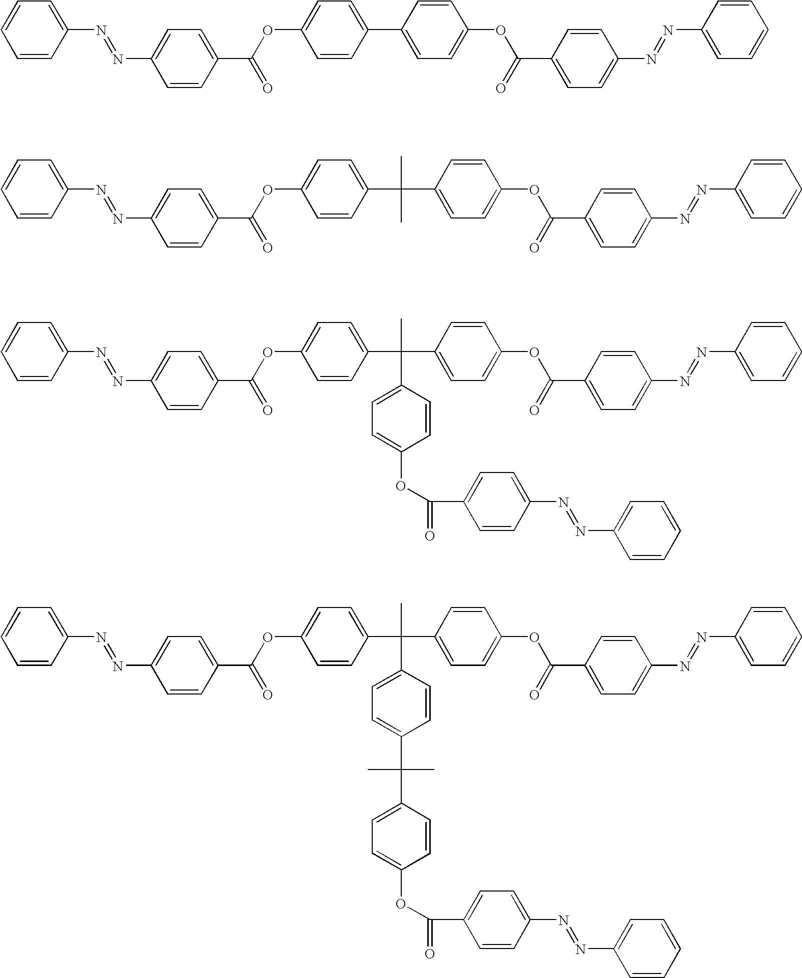

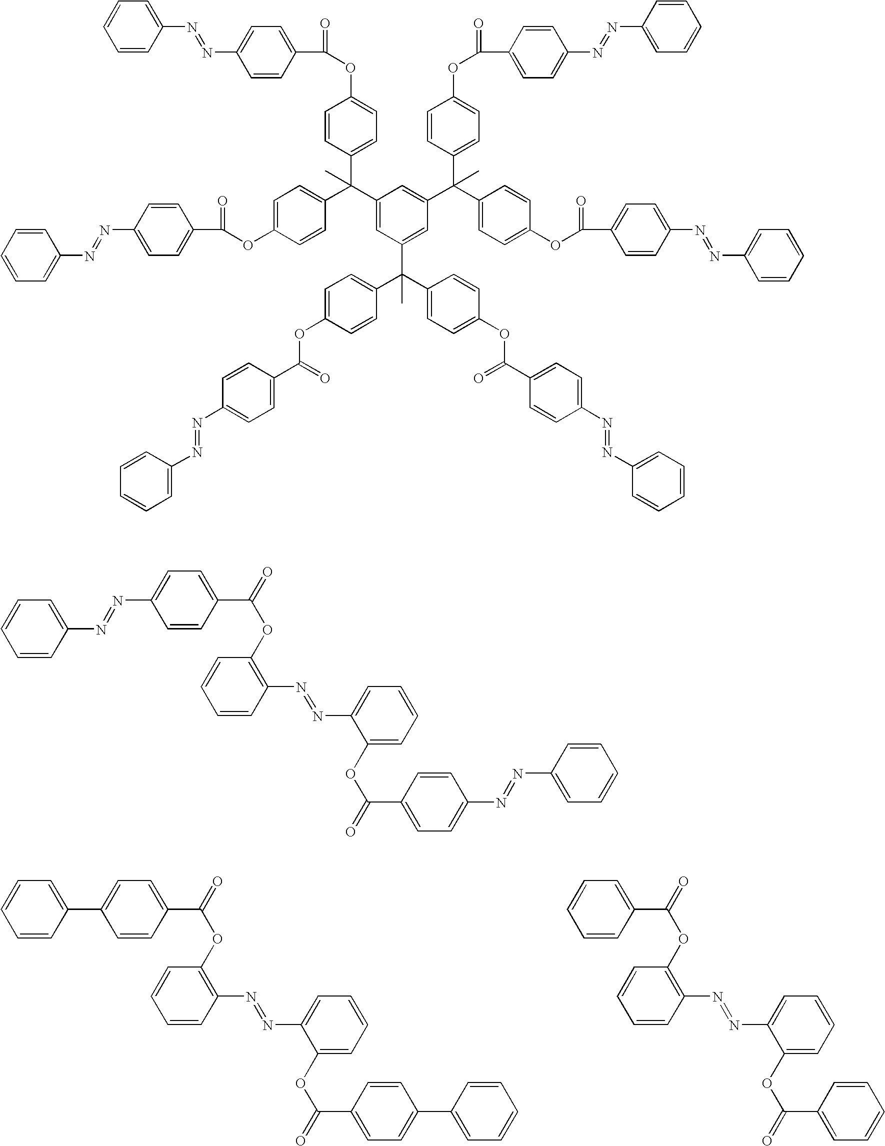

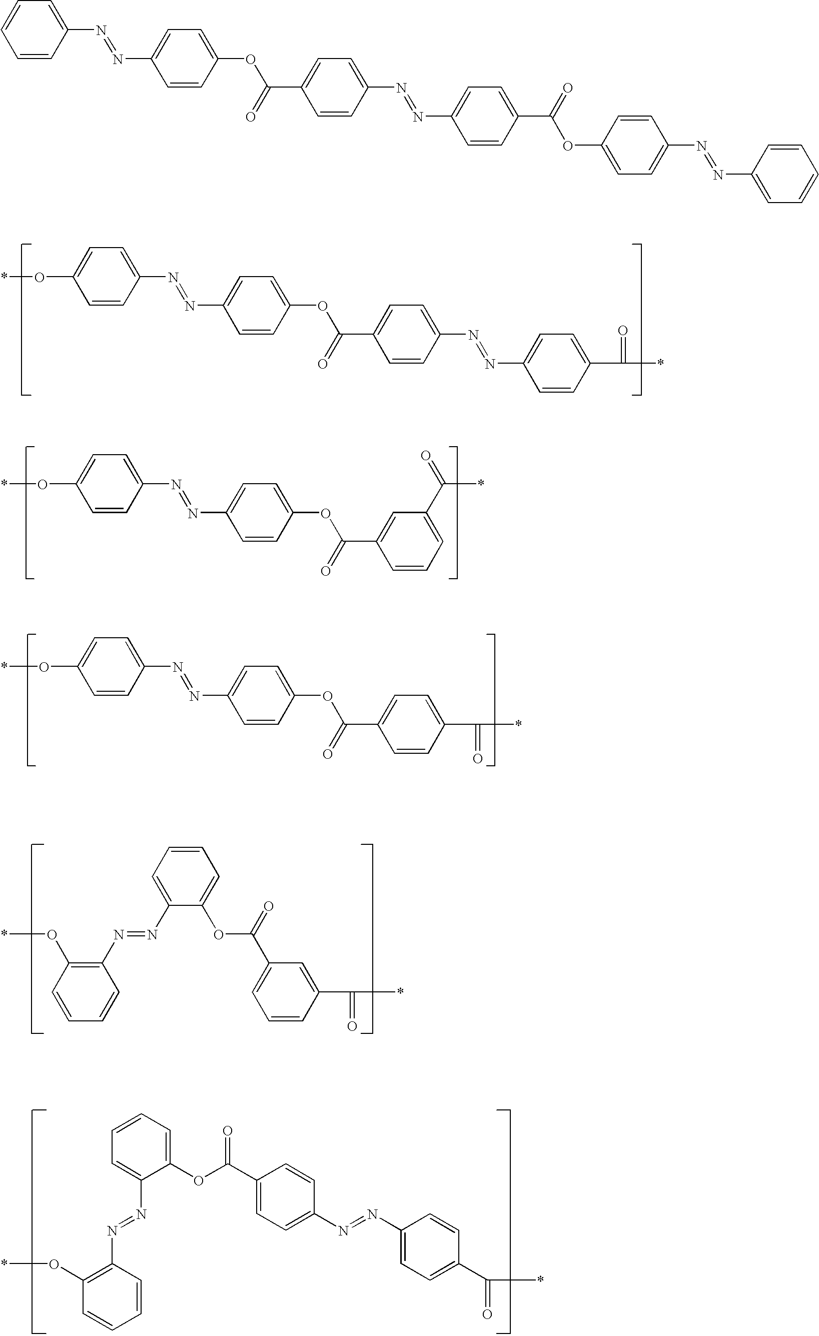

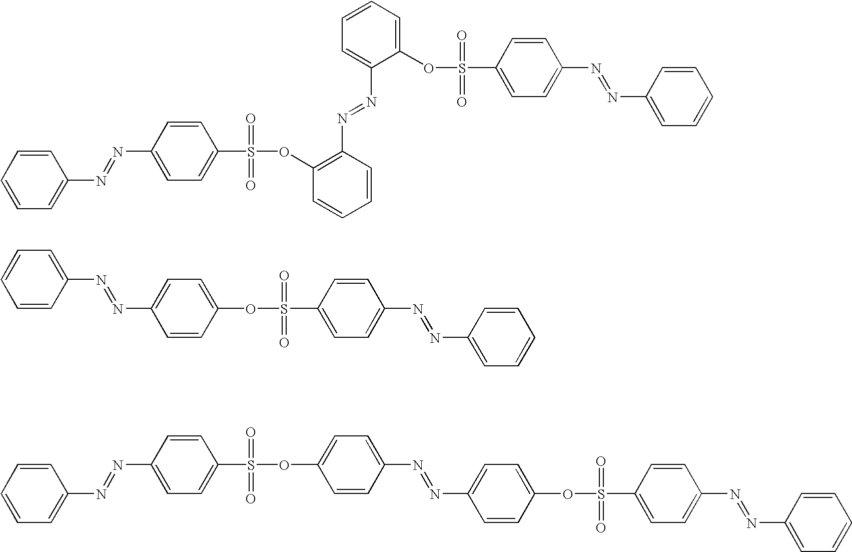

### (Compounds Having a Carbon-Carbon Triple Bond)

The composition for forming a low-dielectric-constant film according to the invention (which may hereinafter be called “film forming composition”) preferably contains a compound having a carbon-carbon triple bond (which may hereinafter be called “Compound (1)”).

The term “compound having a carbon-carbon triple bond” as used herein means an organic compound having at least one carbon-carbon triple bond and it has preferably two or more, more preferably from two to six, still more preferably from two to four carbon-carbon triple bonds. The number of carbon-carbon triple bonds is not limited to the above one when the compound having a carbon-carbon triple bond is a polymer.

The compound having a carbon-carbon triple bond is an aliphatic, aromatic or alicyclic compound and it may have, in the main chain or cyclic structure thereof, a carbon-carbon triple bond or may have, as a substituent, a group having a carbon-carbon triple bond. Examples of the group having a carbon-carbon triple bond include ethynyl, propargyl and 2-butyn-1-yl. These groups may have a substituent further. As the substituent, alkyl groups (C₁₋₂₀ alkyl groups such as methyl, ethyl and propyl) and aryl groups (C₆₋₂₀ aryl groups such as phenyl, 1-naphthyl and 2-naphthyl) are preferred.

The compound (1) having a carbon-carbon triple bond and used in the invention has preferably a cage structure.

The term “cage structure” as used herein means a “cage-type polycarbocyclic structure”, that is, a molecular structure whose cavity is determined by plural carbocycles formed of covalently bonded atoms and in which all points present inside the cavity cannot leave the cavity without passing through the carbocycles. For example, an adamantane structure may be considered as the cage structure. On the other hand, the cyclic structure, of a norbornane (bicyclo[2,2,1]heptane) or the like, having a single-bond bridge is a polycarbocyclic structure but cannot be considered as the cage structure because the single-bond bridged ring of the cyclic compound does not define the cavity of the compound.

The cage structure of the present invention may contain either a saturated or unsaturated bond. It may contain a hetero atom such as oxygen, nitrogen or sulfur, but is preferably a saturated hydrocarbon from the viewpoint of a low dielectric constant.

Preferred examples of the cage structure of the invention include adamantane, biadamantane, diamantane, triamantane, tetramantane and dodecahedrane, of which adamantane, biadamantane and diamantane are more preferred. Of these, biadamantane and diamantane are especially preferred because they have a low dielectric constant.

The cage structure according to the invention may have one or more substituents. The substituent is an atom or group selected from halogen atoms (fluorine, chlorine, bromine and iodine atoms), linear, branched or cyclic C₁₋₁₀ alkyl groups (such as methyl, t-butyl, cyclopentyl and cyclohexyl), C₂₋₁₀ alkenyl groups (such as vinyl and propenyl), C₂₋₁₀ alkynyl groups (such as ethynyl and phenylethynyl), C₆₋₂₀ aryl groups (such as phenyl, 1-naphthyl and 2-naphthyl), C₂₋₁₀ acyl groups (such as benzoyl), C₂₋₁₀ alkoxycarbonyl groups (such as methoxycarbonyl), C₁₋₁₀ carbamoyl groups (such as N,N-diethylcarbamoyl), C₆₋₂₀ aryloxy groups (such as phenoxy), C₆₋₂₀ arylsulfonyl groups (such as phenylsulfonyl), nitro group, cyano group, and silyl groups (such as triethoxysilyl, methyldiethoxysilyl and trivinylsilyl).

In the invention, the cage structure is preferably from divalent to tetravalent. A group to be bound to such a cage structure may be a monovalent or polyvalent substituent or a divalent or other polyvalent linking group. The cage structure is more preferably divalent or trivalent, especially preferably divalent. The term “valence” as used herein means the number of chemical bonds.

The compound having a carbon-carbon triple bond and a cage structure is preferably a compound represented by any one of the following formulas (I) to (III):

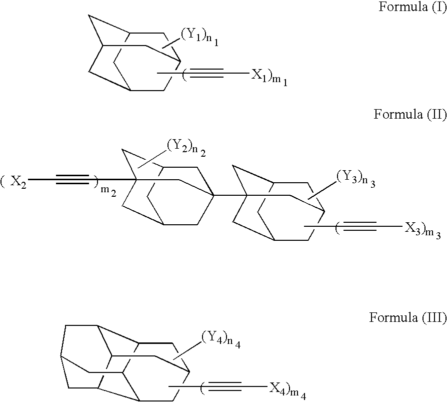

In the formulas (I) to (III), X₁(s) to X₄(s) each independently represents an atom or group selected from hydrogen atom, alkyl groups (preferably, C₁₋₁₀ ones), alkenyl groups (preferably, C₂₋₁₀ ones), alkynyl groups (preferably, C₂₋₁₀ ones), aryl groups (preferably, C₆₋₂₀ ones), silyl groups (preferably, C₀₋₂₀ ones), acyl groups (preferably, C₂₋₁₀ acyl ones), alkoxycarbonyl groups (preferably, C₂₋₁₀ ones), and carbamoyl groups (preferably, C₁₋₂₀ ones), of which the atom or group selected from hydrogen atom, C₁₋₁₀ alkyl groups, C₆₋₂₀ aryl groups, C₀₋₂₀ silyl groups, C₂₋₁₀ acyl groups, C₂₋₁₀ alkoxycarbonyl groups, and C₁₋₂₀ carbamoyl groups are preferred; hydrogen atom and C₆₋₂₀ aryl groups are more preferred; and hydrogen atom is especially preferred.

Y₁(s) to Y₄(s) each independently represents an atom or group selected from halogen atoms (such as fluorine, chlorine and bromine), alkyl groups (preferably, C₁₋₁₀ ones), aryl groups (preferably, C₆₋₂₀ ones), and silyl groups (preferably, C₀₋₂₀ ones), of which the C₁₋₁₀ alkyl groups and C₆₋₂₀ aryl groups which may have a substituent are more preferred and alkyl groups (such as methyl) are especially preferred.

X₁(s) to X₄(s) and Y₁(s) to Y₄(s) may each be substituted further. In this case, the substituents described above as X₁(s) to X₄(s) and Y₁(s) to Y₄(s) are preferred.

In the above formulas, m₁ to m₄ each independently stands for an integer from 1 to 14, preferably from 1 to 4, more preferably from 1 to 3, especially preferably 2;

n₁ and n₄ each independently stands for an integer from 0 to 13; preferably from 0 to 4, more preferably 0 or 1, especially preferably 0.

In the invention, the monomer having a cage structure is preferably a compound selected from the group consisting of compounds represented by the above-described formulas (II) and (III), more preferably compounds represented by the formula (III).

The compound having a carbon-carbon triple bond and a cage structure is preferably a polymer of the compound (monomer) having at least two carbon-carbon triple bonds and a cage structure.

The followings are specific examples, but not limited thereto, of the compound (monomer) having a cage structure usable in the invention.

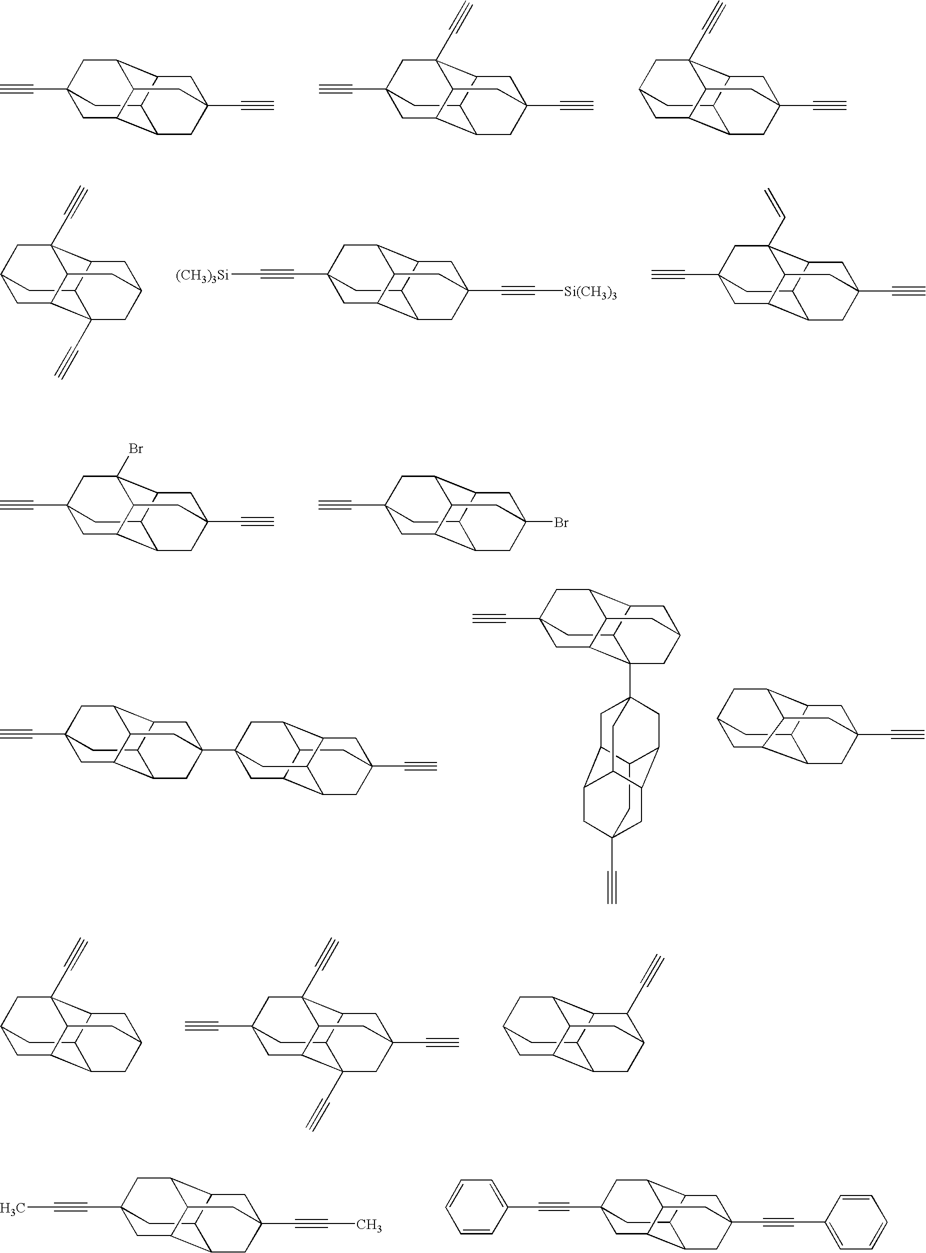

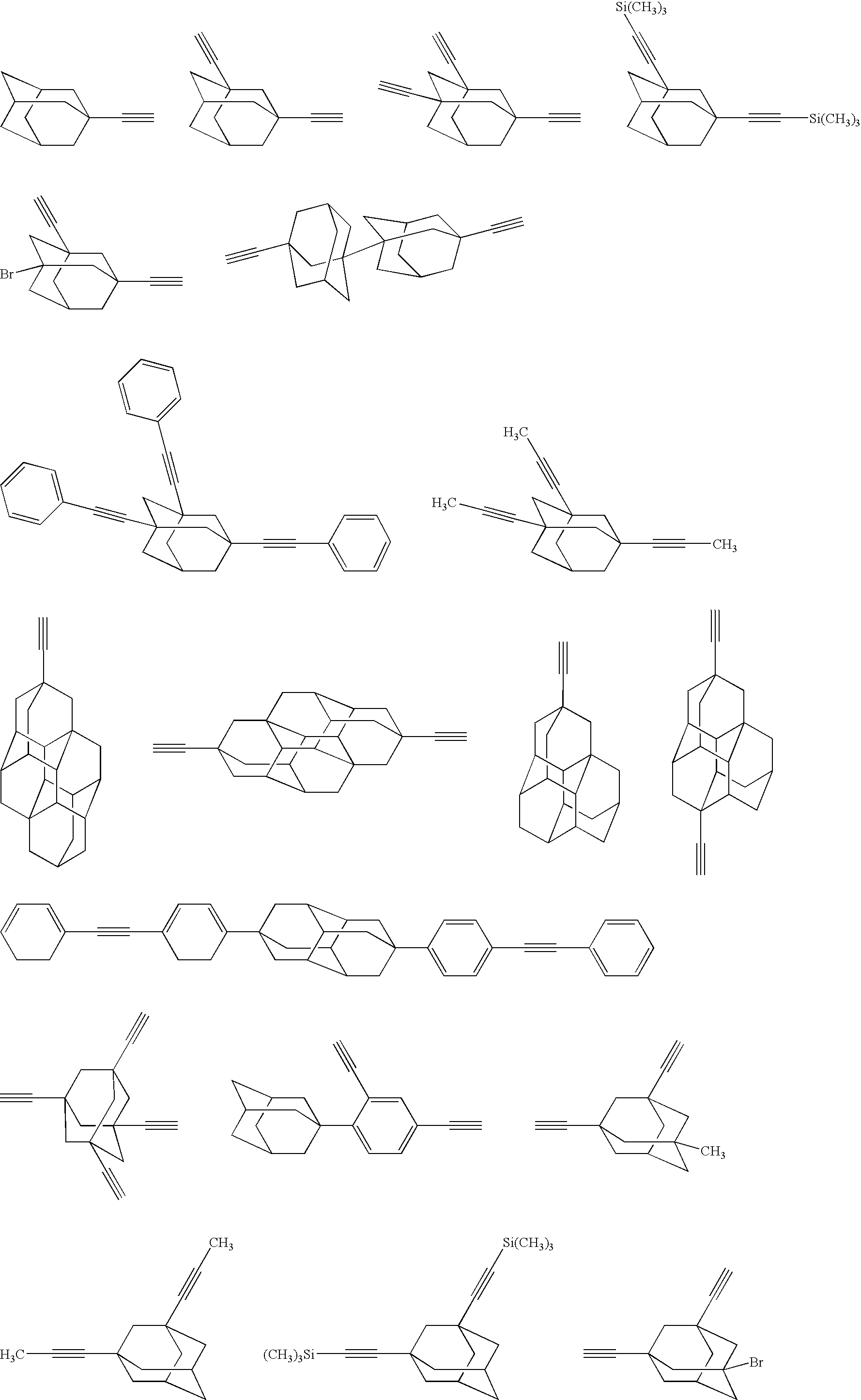

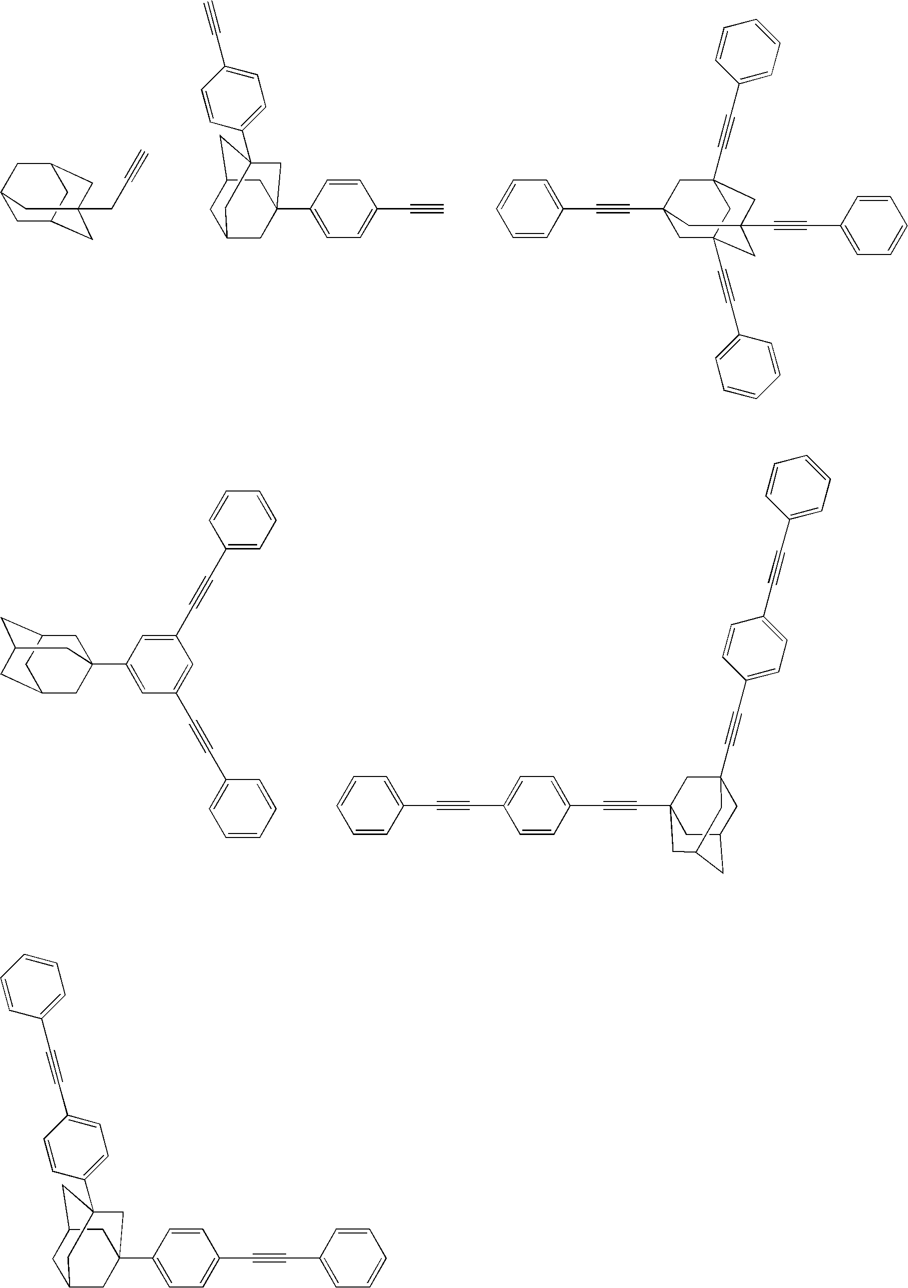

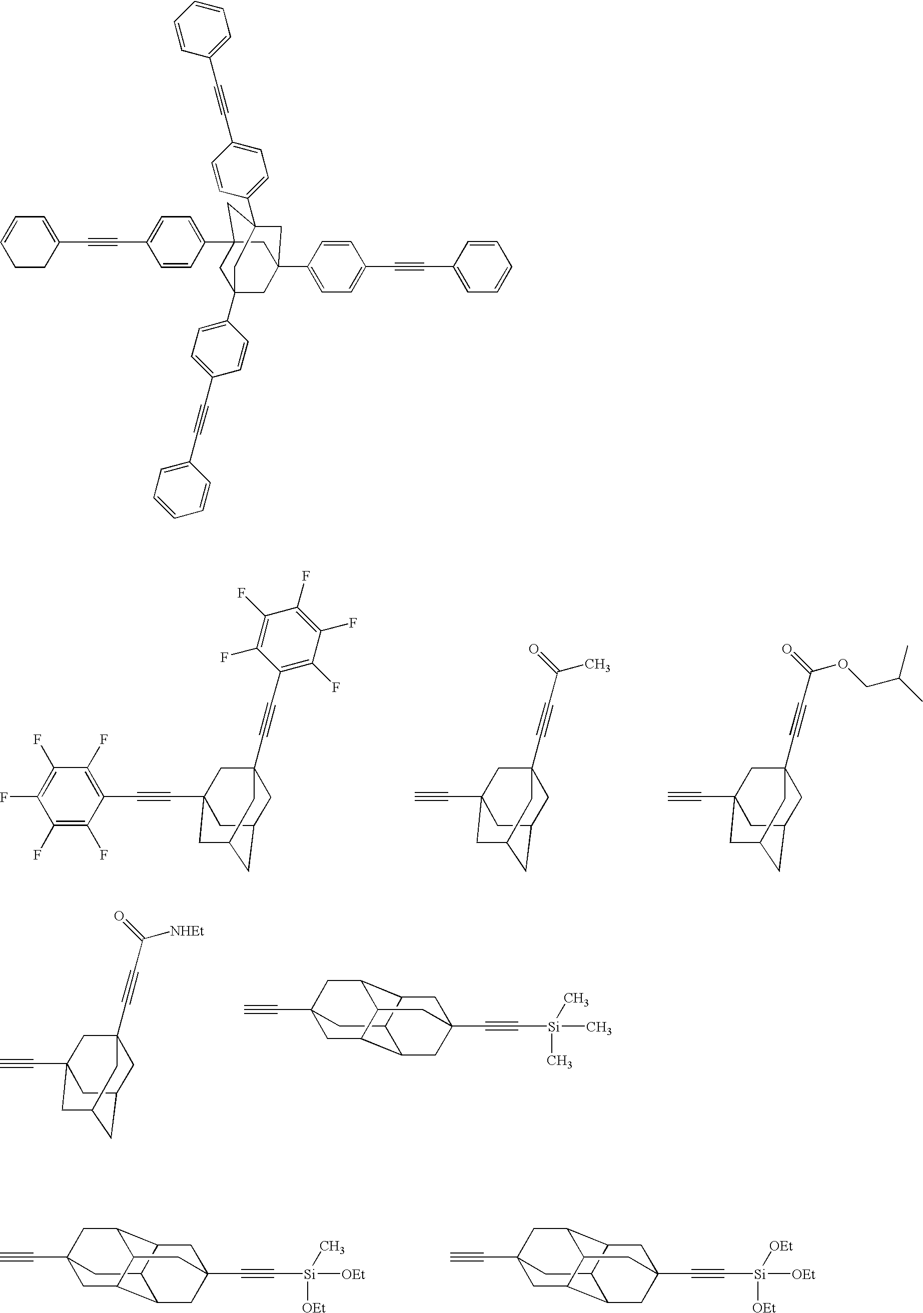

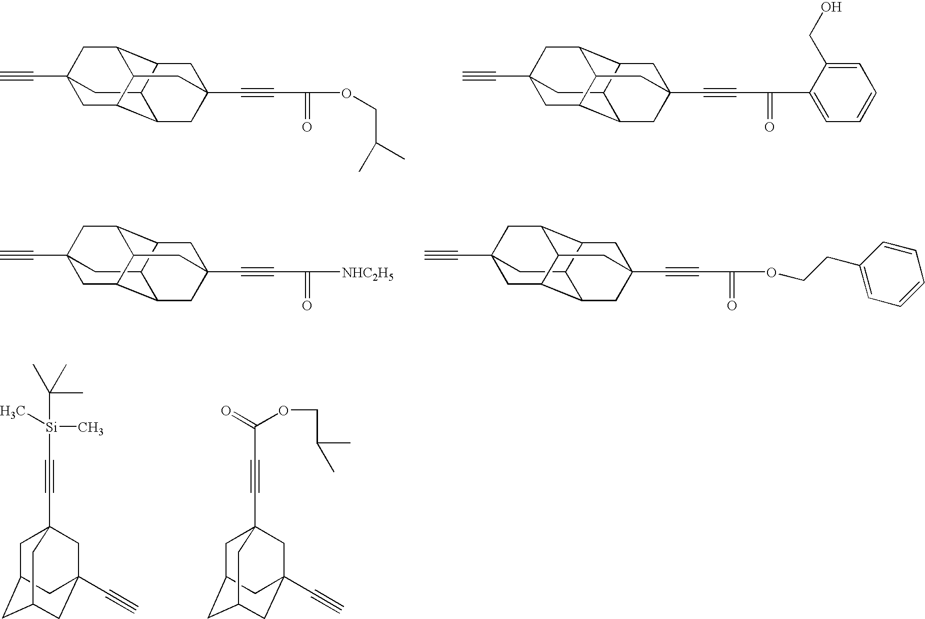

The compound (monomer) having a carbon-carbon triple bond and a cage structure may contain a hetero atom and an aromatic ring, but is preferably free of them in order to reduce its dielectric constant. In short, the compound composed only of carbon atoms and hydrogen atoms and not containing an aromatic ring is especially preferred.

The compound (monomer) having a carbon-carbon triple bond and a cage structure can be synthesized, for example, by using commercially available diamantane as a raw material, reacting it with bromine in the presence or absence of an aluminum bromide catalyst to introduce a bromine atom into the desired position of diamantane, causing a Friedel-Crafts reaction between the resulting compound with vinyl bromide in the presence of a Lewis acid such as aluminum bromide, aluminum chloride or iron chloride to introduce a 2,2-dibromoethyl group, and then converting it into an ethynyl group through the HBr elimination using a strong base. More specifically, it can be synthesized in accordance with the process described in Macromolecules, 24, 5266-5268 (1991) or 28, 5554-5560 (1995), Journal of Organic Chemistry, 39, 2995-3003 (1974) or the like.

An alkyl group or silyl group may be introduced by making the hydrogen atom of the terminal acetylene group anionic by butyl lithium or the like and then reacting the resulting compound with an alkyl halide or silyl halide.

The compounds having a carbon-carbon triple bond and a cage structure may be used either singly or in combination. When the compound having a cage structure to be used in the invention is a polymer of the monomer having a carbon-carbon triple bond and a cage structure, the polymer may be available from a plurality of the monomers different in kind or a copolymer further containing another monomer.

It is preferred to carry out polymerization of the monomer having a carbon-carbon triple bond and a cage structure by using a solvent as in solution polymerization, precipitation polymerization, emulsion polymerization or suspension polymerization, with the solution polymerization being especially preferred.

In the invention, the polymerization reaction of the monomer having a carbon-carbon triple bond is carried out preferably in the presence of a radical generator.

For example, the monomer having a carbon-carbon triple bond can be polymerized in the presence of a radical generator that generates, by heating, a free radical such as carbon radical or oxygen radical.

Preferred examples of the radical generator include organic peroxides, for example, ketone peroxides such as “PERHEXA H”, peroxyketals such as “PERHEXA TMH”, hydroperoxides such as “PERBUTYL H-69”, dialkyl peroxides such as “PERCUMYL D”, “PERBUTYL C” and “PERBUTYL D”, diacyl peroxides such as “NYPER BW”, peroxyesters such as “PERBUTYL Z” and “PERBUTYL L”, and peroxydicarbonates such as “PEROYL TCP”, (each, trade name; commercially available from NOF Corporation), diisobutyryl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, di(4-t-butylchlorohexyl) peroxydicarbonate, di(2-ethylhexyl) peroxydicarbonate, t-hexyl peroxyneodecanoate, t-butyl peroxyneodecanoate, t-butyl peroxyneoheptanoate, t-hexyl peroxypivalate, t-butyl peroxypivalate, di(3,5,5-trimethylhexanoyl) peroxide, dilauroyl peroxide, 1,1,3,3-tetramethylbutyl peroxy-2-ethylhexanoate, disuccinic acid peroxide, 2,5-dimethyl-2,5-di(2-ethylhexanoylperoxy)hexane, t-hexyl peroxy-2-ethylhexanoate, di(4-methylbenzoyl) peroxide, t-butyl peroxy-2-ethylhexanoate, di(3-methylbenzoyl) peroxide, benzoyl(3-methylbenzoyl) peroxide, dibenzoyl peroxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di-(t-butylperoxy)cyclohexyl)propane, t-hexyl peroxyisopropylmonocarbonate, t-butyl peroxymaleic acid, t-butyl peroxy-3,5,5-trimethylhexanoate, t-butyl peroxylaurate, t-butyl peroxyisopropylmonocarbonate, t-butyl peroxy-2-ethylhexylmonocarbonate, t-hexyl peroxybenzoate, 2,5-dimethyl-2,5-di(benzoylperoxy)hexane, t-butyl peroxyacetate, 2,2-di-(t-butylperoxy)butane, t-butyl peroxybenzoate, n-butyl-4,4-di-t-butyl peroxyvalerate, di(2-t-butylperoxyisopropyl)benzene, dicumyl peroxide, di-t-hexyl peroxide, 2,5-dimethyl-2,5-di(t-butylperoxy)hexane, t-butylcumyl peroxide, di-t-butyl peroxide, p-methane hydroperoxide, 2,5-dimethyl-2,5-di(t-butylperoxy)hexine-3, diisopropylbenzene hydroperoxide, 1,1,3,3-tetramethylbutyl hydroperoxide, cumene hydroperoxide, t-butyl hydroperoxide, 2,3-dimethyl-2,3-diphenylbutane, 2,4-dichlorobenzoyl peroxide, o-chlorobenzoyl peroxide, p-chlorobenzoyl peroxide, tris-(t-butylperoxy)triazine, 2,4,4-trimethylpentyl peroxyneodecanoate, α-cumyl peroxyneodecanoate, t-amyl peroxy-2-ethylhexanoate, t-butyl peroxyisobutyrate, di-t-butyl peroxyhexahydroterephthalate, di-t-butyl peroxytrimethyladipate, di-3-methoxybutyl peroxydicarbonate, di-isopropyl peroxydicarbonate, t-butyl peroxyisopropylcarbonate, 1,6-bis(t-butylperoxycarbonyloxy)hexane, diethylene glycol bis(t-butyl peroxycarbonate) and t-hexyl peroxyneodecanoate.

Preferred examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and VA-057” (each, trade name, commercially available from Wako Pure Chemical Industries), 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutyronitrile), 1,1-azobis(cyclohexane-1-carbonitrile), 1-[(1-cyano-1-methylethyl)azo]formamide, 2,2-azobis {2-methyl-N-[1,1-bis(hydroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazolin-2-yl)propane]dihydrochloride, 2,2-azobis[2-(2-imidazolin-2-yl)]propane]disulfate dihydrate, 2,2-azobis{2-[1-(2-hydroxyethyl)-2-imidazolin-2-yl]propane}dihydrochloride, 2,2-azobis[2-[2-imidazolin-2-yl]propane], 2,2-azobis(1-imino-1-pyrrolidino-2-methylpropane)dihydrochloride, 2,2-azobis(2-methylpropionamidine)dihydrochloride, 2,2-azobis[N-(2-carboxyethyl)-2-methylpropionamidine]tetrahydrate, dimethyl-2,2-azobis(2-methylpropionate), 4,4-azobis(4-cyanovaleric acid) and 2,2-azobis(2,4,4-trimethylpentane).

Of these, the organic peroxides are most preferred, because they enable effective polymerization by the addition of a small amount.

In the invention, these radical generators may be used either singly or in combination.

The amount of the radical generator to be used in the present invention is preferably from 0.001 to 2 moles, more preferably from 0.01 to 1 mole, especially preferably from 0.05 to 0.75 mole per mole of the monomer.

The optimum conditions for the polymerization reaction in the invention differ, depending on the kind or concentration of the radical generator, monomer or solvent. The internal temperature is preferably from 0 to 250° C., more preferably from 50 to 220° C., especially preferably from 100 to 200° C., while the reaction time is preferably from 0.1 to 50 hours, more preferably from 0.2 to 20 hours, especially preferably from 0.3 to 10 hours.

In order to suppress the inactivation of the radical generator due to oxygen, the reaction is performed preferably in an inert gas atmosphere (such as nitrogen or argon). The oxygen concentration during the reaction is preferably 100 ppm or less, more preferably 50 ppm or less, especially preferably 20 ppm or less.

The cage structure in the invention may be substituted as a pendant group in the polymer or may become a portion of the polymer main chain, but latter is preferred. If the cage structure becomes a portion of the polymer main chain, this means that the polymer chain is broken by the removal of the cage compound from the polymer. In this case, the cage structure may be connected directly via a monovalent linking group or by an appropriate divalent linking group. Example of the linking group include —C(R₁₁)(R₁₂)—, —C(R₁₃)═C(R₁₄)—, —C≡C—, arylene group, —CO—, —O—, —SO₂—, —N(R₁₅)—, and —Si(R₁₆)(R₁₇)—, and combination thereof. In these groups, R₁₁ to R₁₇ each independently represents a group similar to those exemplified as X₁ to X₄ and Y₁ to Y₄ in the formulas (I) to (III), preferably a hydrogen atom, an alkyl group, an alkenyl group, an alkynyl group or an aryl group. These linking groups may be substituted by any substituent and as the substituent, the above-described ones are preferred.

Of these, the linking groups in which R₁₁ to R₁₇ each represents a hydrogen atom, a methyl group or ethyl group are more preferred and —C(R₁₁)(R₁₂)—, —CH═CH—, —C≡C—, arylene group, —O—, and —Si(R₁₆)(R₁₇)—, and combination thereof are more preferred, with —C(R₁₁)(R₁₂)— and —CH═CH— being especially preferred in consideration of a low dielectric constant.

In the invention, the polymer has a weight average molecular weight of preferably from 1000 to 500000, more preferably from 3000 to 300000, especially preferably from 5000 to 200000. The polymer having a molecular weight smaller than 1000 has a problem that it is thinned by heating. The polymer having a molecular weight exceeding 500000, on the other hand, has a deteriorated solubility in a solvent and may cause a problem.

Polydispersity (Mw/Mn) is one of indicators showing the spread of molecular weight distribution. The molecular weight distribution becomes narrower as the Mw/Mn reaches 1. The polymer of the invention has a polydispersity of typically 100 or less, preferably 50 or less, more preferably 30 or less in order to suppress generation of cracks and deterioration in mechanical strength during formation of an insulating film using the polymer and improve the uniformity of the surface condition.

The polymers of the invention may be used either singly or as a mixture of two or more of them.

The film forming composition of the invention may contain an organic solvent. It is usable as a coating solution. No particular limitation is imposed on the organic solvent. Examples include alcohol solvents such as methanol, ethanol, 2-propanol, 1-butanol, 2-ethoxymethanol, 3-methoxypropanol and 1-methoxy-2-propanol; ketone solvents such as acetone, acetylacetone, methyl ethyl ketone, methyl isobutyl ketone, 2-pentanone, 3-pentanone, 2-heptanone, 3-heptanone, cyclopentanone and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole and veratrole; aromatic hydrocarbon solvents such as mesitylene, ethylbenzene, diethylbenzene, propylbenzene and t-butylbenzene; and amide solvents such as N-methylpyrrolidinone and dimethylacetamide. These solvents may be used either singly or in combination.

Of these, more preferred organic solvents are 1-methoxy-2-propanol, propanol, acetylacetone, cyclohexanone, propylene glycol monomethyl ether acetate, butyl acetate, methyl lactate, ethyl lactate, γ-butyrolactone, anisole, mesitylene, and t-butylbenzene, with 1-methoxy-2-propanol, cyclohexanone, propylene glycol monomethyl ether acetate, ethyl lactate, γ-butyrolactone, t-butylbenzene and anisole being especially preferred.

In the invention, solvents used for the polymerization reaction preferably do not contain a hydrogen atom which will covalently bind to an SP3 carbon. Examples of the solvent having no hydrogen atom which will covalently bind to an SP3 carbon include diphenyl ether.

The solid concentration of the film forming composition of the invention is preferably from 1 to 50 mass %, more preferably from 2 to 15 mass %, especially preferably from 3 to 10 mass %.

The term “solid content” as used herein means a total content constituting an insulating film available using the composition.

The polymer having a cage structure and available by the invention preferably has a sufficient solubility in an organic solvent. The solubility which enables a concentration of 3 mass % or greater, more preferably 5 mass % or greater, especially preferably 10 mass % or greater at 25° C. in cyclohexanone or anisole is preferred.

The content of metals, as an impurity, of the film forming composition of the invention is preferably as small as possible. The metal content of the film forming composition can be measured with high sensitivity by an ICP-MS method and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process increases the dielectric constant of the film obtained by the invention. The transition metal content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis. When W ray is employed as an X-ray source, the metal concentrations of metal elements such as K, Ca, Ti, Cr, Mn, Fe, Co, Ni, Cu, Zn, and Pd can be measured. The concentrations of each of the metals is preferably from 100×10¹⁰ atom·cm⁻² or less, more preferably 50×10¹⁰ atom·cm⁻² or less, especially preferably 10×10¹⁰ atom cm⁻² or less. In addition, the concentration of Br, a halogen atom, can also be measured. Its remaining amount is preferably 10000×10¹⁰ atom·cm⁻² or less, more preferably 1000×10¹⁰ atom·cm⁻², especially preferably 400×10¹⁰ atom·cm⁻². Moreover, the concentration of Cl, a halogen atom, can also be observed. In order to prevent it from damaging a CVD apparatus, etching apparatus or the like, its remaining amount is preferably 100×10¹⁰ atom·cm⁻² or less, more preferably 50×10¹⁰ atom·cm⁻², especially preferably 10×10 atom·cm⁻².

To the film forming composition of the invention, additives such as radical generator (to be added for a purpose different from that of the above-described radical generator for polymerization of a compound having a carbon-carbon triple bond), colloidal silica, surfactant, silane coupling agent and adhesion promoter may be added so as not to impair the properties (such as heat resistance, dielectric constant, mechanical strength, coating properties, and adhesion) of an insulating film obtained using it.

The term “radical generator” means a compound generating radicals such as carbon, oxygen and nitrogen when exposed to heat or light energy and it has a function of promoting a film curing reaction.

In the invention, any colloidal silica may be used. For example, a dispersion obtained by dispersing high-purity silicic anhydride in a hydrophilic organic solvent or water and having an average particle size of typically from 5 to 30 nm, preferably from 10 to 20 nm and a solid concentration of from about 5 to 40 mass % can be used.

In the invention, any surfactant may be added insofar as it improves the coating properties or film forming properties. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably 0.01 mass % or greater but not greater than 1 mass %, more preferably 0.1 mass % or greater but not greater than 0.5 mass % based on the total amount of the film forming composition.

The silicone surfactant to be used in the invention contains at least one Si atom. It is a known compound having a Si atom and at the same time having interfacial activity. A compound having an alkylene-oxide- and dimethylsiloxane-containing structure is preferred. Especially, a structure containing the following chemical formula is preferred.

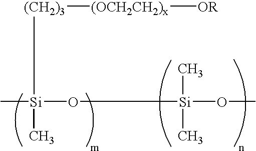

In the above formula, R represents a hydrogen atom or an alkyl group (preferably a C₁₋₅ alkyl group), x stands for an integer from 1 to 20, and m and n each independently represents an integer from 2 to 100. A plurality of Rs may be the same or different.

Examples of the silicone surfactant to be used in the invention include “BYK 306” and “BYK 307” (each, trade name; product of BYK Chemie), “SH7PA”, “SH21PA”, “SH28PA”, and “SH30PA” (each, trade name; product of Dow Corning Toray Silicone) and “Troysol S366” (trade name; product of Troy Chemical).

As the nonionic surfactant to be used in the invention, any known nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any known fluorosurfactant is usable. Examples include perfluorooctyl polyethylene oxide, perfluorodecyl polyethylene oxide and perfluorododecyl polyethylene oxide.

As the acrylic surfactant to be used in the invention, any known acrylic surfactant is usable. Examples include (meth)acrylic acid copolymers.

Any known silane coupling agent capable of improving the adhesion with a substrate may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. These silane coupling agents may be used either singly or in combination.

The silane coupling agent may be added preferably in an amount of 10 parts by mass or less, especially preferably from 0.05 to 5 parts by mass based on 100 parts by mass of the total solid content.

In the invention, any adhesion promoter may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate diisopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion promoter. The amount of the adhesion promoter is preferably 10 parts by mass or less, especially preferably from 0.05 to 5 parts by mass, based on 100 parts by mass of the total solid content.

To the film forming composition of the invention, a pore forming factor can be added so as not to damage the mechanical strength of the film. Addition of it enables conversion of the film into a porous one and reduction in the dielectric constant of the film. The pore size is 10 nm at the maximum, preferably 5 nm, especially preferably 1 nm.

Although no particular limitation is imposed on the pore forming factor as an additive to serve as a pore forming agent, a non-metallic compound is preferred. The pore forming agent must satisfy both the solubility in a solvent to be used for a film forming coating solution and compatibility with the polymer of the invention. The boiling point or decomposition point of the pore forming agent is preferably from 100 to 500° C., more preferably from 200 to 450° C., especially preferably from 250 to 400° C. The molecular weight of it is preferably from 200 to 50000, more preferably from 300 to 10000, especially preferably from 400 to 5000. The amount of it in terms of mass % is preferably from 0.5 to 75%, more preferably from 0.5 to 30%, especially preferably from 1 to 20% relative to the polymer for forming a film. The polymer may contain a decomposable group as the pore forming factor. The decomposition point of it is preferably from 100 to 500° C., more preferably from 200 to 450° C., especially preferably from 250 to 400° C. The content of the decomposable group is, in terms of mole %, from 0.5 to 75%, more preferably from 0.5 to 30%, especially preferably from 1 to 20% relative to the amount of the monomer of the film forming polymer.

The film can be formed by applying the film forming composition of the invention onto a substrate by a desired method such as spin coating, roller coating, dip coating or scan coating, and then heating the substrate to remove the solvent. For drying off the solvent, the substrate is heated preferably for 0.1 to 5 minutes at from 100 to 250° C.

As the method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate.

When the solution of the film forming composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the film forming composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge portion of the substrate. The heat treatment method is not particularly limited, but ordinarily employed methods such as hot plate heating, heating with a furnace, and heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “α series” (trade name; product of Tokyo Electron) is preferred.

It is especially preferred to cure (bake) the polymer of the invention by applying it onto a substrate and then heating. For this purpose, the polymerization reaction, at the time of post heating, of a carbon-carbon triple bond remaining in the polymer may be utilized. The post heat treatment is performed at preferably from 100 to 450° C., more preferably from 200 to 420° C., especially preferably from 350 to 400° C., for preferably from 1 minute to 2 hours, more preferably from 10 minutes to 1.5 hours, especially preferably from 30 minutes to 1 hour. The post heat treatment may be performed in several times. This post heat treatment is performed especially preferably in a nitrogen atmosphere in order to prevent thermal oxidation due to oxygen.

In the invention, the polymer may be cured (baked) not by heat treatment but by exposure to high energy radiation to cause polymerization reaction of a carbon-carbon triple bond remaining in the polymer. Examples of the high energy radiation include an electron beam, ultraviolet ray and X ray. The curing method is not particularly limited to these methods.

When an electron beam is employed as high energy radiation, the energy is preferably from 0 to 50 keV, more preferably from 0 to 30 keV, especially preferably 20 keV or less. Total dose of an electron beam is preferably 5 μC/cm² or less, more preferably 2 μC/cm² or less, especially preferably 1 μC/cm² or less. The substrate temperature when it is exposed to an electron beam is preferably from 0 to 450° C., more preferably from 0 to 400° C., especially preferably from 0 to 350° C. Pressure is preferably from 0 to 133 kPa, more preferably from 0 to 60 kPa, especially preferably from 0 to 20 kPa. From the viewpoint of preventing oxidation of the polymer of the invention, an inert gas such as Ar, He or nitrogen is preferably employed for the atmosphere around the substrate. An oxygen, hydrocarbon or ammonia gas may be added for the purpose of causing interaction with an electron beam to generate plasma, electromagnetic wave or reaction with chemical species. In the invention, exposure to an electron beam may be carried out in plural times. In this case, conditions for exposure to an electron beam are not necessarily the same but they may be varied each time.

An ultraviolet ray may be employed for high energy radiation. The radiation wavelength range of an ultraviolet ray is preferably from 190 to 400 nm, while its output immediately above the substrate is preferably from 0.1 to 2000 mWcm⁻². The substrate temperature upon exposure to an ultraviolet ray is preferably from 250 to 450° C., more preferably from 250 to 400° C., especially preferably from 250 to 350° C. An inert gas such as Ar, He or nitrogen is preferably employed for the atmosphere around the substrate from the viewpoint of preventing oxidation of the polymer of the invention. The pressure at this time is preferably from 0 to 133 kPa.

A low-dielectric-constant film can be formed using the film forming composition of the invention. The film has a dielectric constant of preferably 3.0 or less, more preferably 2.6 or less, still more preferably 2.5 or less.

When the film obtained from the low-dielectric-constant film forming composition of the invention is used as an interlayer insulating film for a semiconductor, a metal-migration preventing barrier layer may be laid on the side surface of the interconnect of its interconnect structure. In the interconnect structure, a cap layer, an interlayer adhesion layer or etching stopper layer may also be disposed on the upper or bottom surface of the interconnect or interlayer insulating film in order to prevent exfoliation of it during CMP (Chemical Mechanical Polishing). Moreover, an interlayer insulating film may be composed of plural layers using another material as needed.

The film obtained using the film forming composition of the invention can be etched for copper metallization or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, an ashing residue may be removed by washing.

The film obtained using the film forming composition of the invention may be subjected to CMP for planarizing a copper plated portion after processing for copper metallization. As a CMP slurry (chemical solution), a commercially available one (for example, product of Fujimi Incorporated, Rodel Nitta, JSR or Hitachi Chemical) can be used as needed. As a CMP apparatus, a commercially available one (for example, product of Applied Materials or Ebara Corporation) can be used as needed. After CMP, the film can be washed in order to remove a slurry residue therefrom.

The film available from the film forming composition of the invention can be used for various purposes. For example, it is suited as an insulating film for semiconductor devices such as LSI, system LSI, DRAM, SDRAM, RDRAM, and D-RDRAM, and for electronic parts such as multi-chip module multilayer wiring boards. More specifically, it is usable as an interlayer insulating film for semiconductors, etching stopper film, surface protective film, and buffer coat film and moreover, as a passivation film in LSI, α-ray block film, cover lay film in flexographic plates, overcoat film, cover coat for flexible copper-lined plates, solder resist film, and liquid-crystal alignment film.

As another purpose, the film of the invention can be used as a conductive film after doping it with an electron donor or acceptor, thereby imparting conductivity to it.

### EXAMPLES

The present invention will next be described by the following Examples, but the scope of it is not limited by them.

### Synthesis Example 1

### Synthesis of Compound A-1

In a reactor, 4-aminoazobenzene 1 (25.0 g, product of Sigma Aldrich), triethylamine (8.6 g) and dry tetrahydrofuran (250 ml) were weighed. By ice cooling, the internal temperature was cooled to 0° C. After stirring, fused trimesic acid chloride 2 (5.6 g, 1,3,5-benzenetricarbonyl trichloride, product of Sigma Aldrich) was added dropwise to the reaction mixture. Stirring was performed for 1 hour. After the temperature was elevated to room temperature and stirring was performed for further 6 hours, tetrahydrofuran was distilled off from the reaction mixture. A solid thus obtained was washed with water, methanol and ethyl acetate to yield crude crystals of Compound A-1. The resulting crude crystals were recrystallized from a tetrahydrofuran type solvent, whereby orange crystals A-1 (14.2 g, 90%) were obtained.

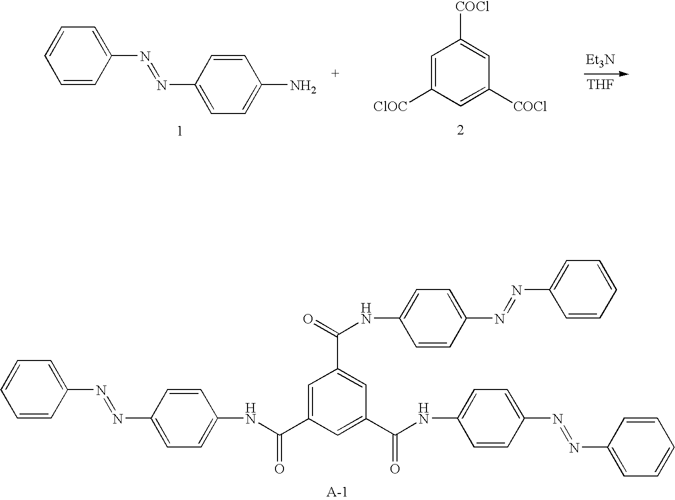

### Synthesis Example 2

### Synthesis of Compound A-2

In a reactor, 4-phenylazophenol 3 (25.0 g, product of Sigma Aldrich), triethylamine (12.8 g) and dry tetrahydrofuran (250 ml) were weighed. By ice cooling, the internal temperature was cooled to 0° C. After stirring, fused trimesic acid chloride 4 (8.4 g) was added dropwise to the reaction mixture. Stirring was performed for 1 hour. After the temperature was elevated to room temperature and stirring was performed for further 6 hours, tetrahydrofuran was distilled off from the reaction mixture. A solid thus obtained was washed with water, methanol and ethyl acetate to yield crude crystals of Compound A-2. The resulting crude crystals were recrystallized from a tetrahydrofuran-methanol type solvent, whereby yellowish orange crystals A-2 (18.2 g, 77%) were obtained.

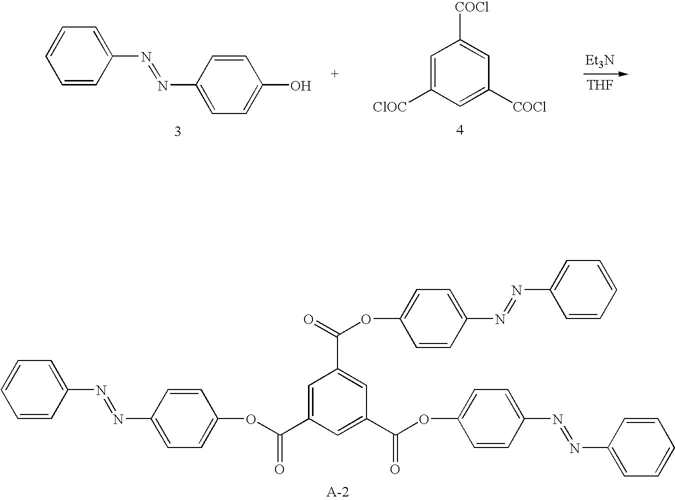

### Synthesis Example 3

### Synthesis of Compound A-3

In a reactor, 2,2′-dihydroxyazobenzene (2.2 g, product of Sigma Aldrich), triethylamine (4.14 g) and dry tetrahydrofuran (100 ml) were weighed. The internal temperature was cooled to 0° C. After stirring, a solution of 4-phenylazobenzoic acid chloride 5 (2.2 g) in 30 ml of dry tetrahydrofuran was added dropwise to the reaction mixture. Stirring was performed for 1 hour. After the temperature was elevated to room temperature and stirring was performed for further 6 hours, tetrahydrofuran was distilled off from the reaction mixture. A solid thus obtained was washed with water, methanol and ethyl acetate to yield crude crystals of Compound A-3. The resulting crude crystals were recrystallized from a tetrahydrofuran type solvent, whereby orange crystals A-3 (6.3 g, 82%) were obtained.

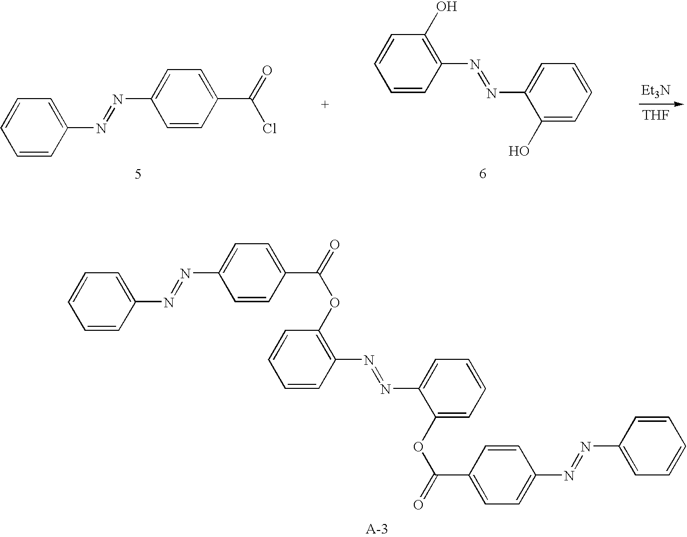

### Synthesis Examples 4 to 6

### Synthesis of Compounds A-4 to A-6

The following compounds A-4 to A-6 were synthesized in accordance with a similar synthesis process.

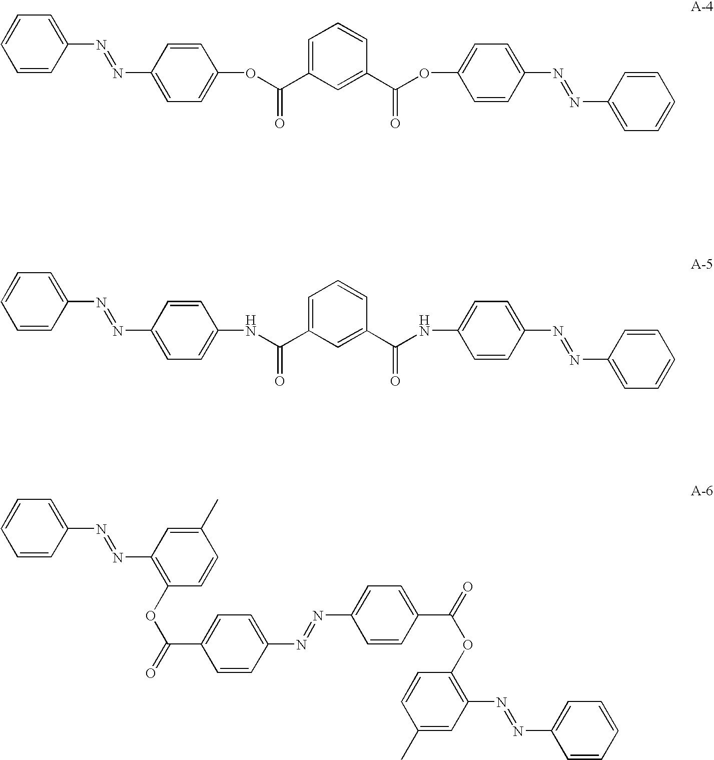

### Example 1

In accordance with the synthesis process as described in Macromolecules, 24, 5266 (1991), 4,9-diethynyldiamantane was synthesized.

100 g of 4,9-diethynyldiamantane and 563 g of diphenyl ether were charged in a reactor. The reactor was heated to an internal temperature of 155° C. while stirring under a nitrogen gas stream to completely dissolve 4,9-diethynyldiamantane. A solution of 21.6 g of dicumyl peroxide (“PERCUMYL D”, trade name; product of NOF) in 18.9 g of diphenyl ether was added dropwise to the reaction mixture over 1 hour while keeping the internal temperature of the reaction mixture at from 150° C. to 160° C.

After the reaction, the reaction mixture cooled to 50° C. was added to 4 L of 2-propanol. A solid thus precipitated was filtered and washed with 2-propanol. The polymer thus obtained was dissolved in 400 ml of THF and the resulting solution was added to 4 L of methanol for reprecipitation and purification. After vacuum drying, 62 g of a polymer (1) having a weight average molecular weight of about 38000 was obtained. Presence of a triple bond in the polymer (1) was confirmed by IR spectrum.

A coating solution was prepared by completely dissolving 0.97 g of the polymer (1) and 0.03 g of Compound A-1 in 9.0 g of cyclohexanone. After the resulting solution was filtered through a 0.1-μm PTEFE filter, the filtrate was spin-coated onto a silicon wafer. The coating was heated at 250° C. for 60 seconds on a hot plate in a nitrogen gas stream and then baked for 60 minutes in a nitrogen-purged oven of 400° C., whereby a 0.5-μm thick uniform film without blisters was obtained. The dielectric constant (measured at 25° C., which will equally apply hereinafter) of the resulting film was calculated from the capacitance value thereof measured at 1 MHz by using a mercury probe (product of Four Dimensions) and an LCR meter “HP4285A” (trade name; product of Yokogawa Hewlett Packard), resulting in 2.39. The appearance of the insulating film thus obtained was observed through a pocket microloupe (×50), product of Peak Optics, but no cracks were found on the surface of the coating.

### Examples 2 to 6

Coating solutions were prepared using Compounds A-2 to A-6 instead of Compound A-1 of Example 1 in amounts as shown in Table 1 and similar evaluation was carried out.

### Comparative Example 1

In a similar manner to Example 1 except that Compound A-1 was replaced by the polymer (1) without changing the amount, a coating solution was prepared and a coating was formed.

The resulting coating was heated at 250° C. for 60 seconds on a hot plate in a nitrogen gas stream and then baked for 60 minutes in a nitrogen-purged oven of 400° C., whereby a 0.5-μm thick uniform film without blisters was obtained. The dielectric constant (measured at 25° C., which will equally apply hereinafter) of the resulting film was calculated from the capacitance value thereof measured at 1 MHz by using a mercury probe (product of Four Dimensions) and an LCR meter “HP4285A” (trade name; product of Yokogawa Hewlett Packard), resulting in 2.39. The appearance of the insulating film thus obtained was observed through a pocket microloupe (×50), product of Peak Optics, but no cracks were found on the coating surface.

### (Evaluation of Heat Resistance)

The films obtained in Examples 1 to 6 and Comparative Example 1 were heated at 400° C. for 30 seconds in the air. A change in the mass was measured and a weight loss (%) was determined.

The results are shown in Table 1.

TABLE 1

| | | Compound | Dielectric | Heat |
|---|---|---|---|---|
| | | (amount, g) | constant | resistance (%) |
| Examples | 1 | A-1 (0.03) | 2.39 | 6.0 |
| | 2 | A-2 (0.05) | 2.38 | 5.8 |
| | 3 | A-3 (0.05) | 2.38 | 8.6 |
| | 4 | A-4 (0.02) | 2.38 | 7.2 |
| | 5 | A-5 (0.03) | 2.39 | 7.0 |
| | 6 | A-6 (0.06) | 2.40 | 5.5 |
| Comparative | 1 | — | 2.39 | 12.0 |
| Example | | | | |

Insulating films formed using the film forming composition prepared in accordance with the process of the invention have excellent heat resistance and a low dielectric constant, suggesting that the composition is useful as an insulating film material.

The composition for forming a low-dielectric-constant film available by the preparation process of the invention is capable of providing an insulating film suited for use as an interlayer insulating film in semiconductor devices and excellent in heat resistance, low dielectric constant, mechanical strength and surface conditions. Moreover, an interlayer insulating film of an electronic device available using the coating solution of it and an electronic device having the insulating film as a layer constituent can also be provided.

The entire disclosure of each and every foreign patent application from which the benefit of foreign priority has been claimed in the present application is incorporated herein by reference, as if fully set forth.

What is claimed is:

1. A composition for forming a low-dielectric-constant film, the composition comprising:
a compound represented by the following formula (A): 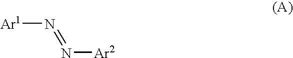
wherein
each of Ar¹ and Ar² independently represents an aryl group that may have a substituent.

2. The composition according to claim 1, further comprising:
a compound having a carbon-carbon triple bond.

3. The composition according to claim 2, wherein
the compound having a carbon-carbon triple bond has a cage structure.

4. The composition according to claim 3, wherein
the cage structure is selected from the group consisting of adamantane, biadamantane, diamantane, triamantane, and tetramantane.

5. An insulating film formed of the composition according to claim 1.

6. An electronic device comprising the insulating film according to claim 5.
